(19) United States
(12) Patent Application Publication
(10) Pub. No.: US 2003/0001124 A1
(43) Pub. Date: Jan. 2, 2003

(54) Safety device of water faucet

(76) Inventor: Chih-Hsien Chen, Taichung Hsien (TW)

Correspondence Address: CHARLES E. BAXLEY, ESQUIRE, Hart, Baxley, Daniels & Holton, 5 Fl, 59 John St, New York, NY, 10038, US

(21) Appl. No.: 09/895,642

(22) Filed: Jul. 2, 2001

(51) Int. Cl. F16K 35/02

(52) U.S. Cl. 251/113

(57) ABSTRACT

A safety device of a water faucet includes a safety bolt mounted on a water faucet to function as a secondary control of operation of the control handle and the control rod, thereby preventing the child from unintentionally touch and drive the control handle so as to protect the child, thereby greatly enhancing the safety of the water faucet.

### BACKGROUND OF THE INVENTION

1. Field of the Invention

The present invention relates to a safety device of a water faucet, and more particularly to a safety device including a safety bolt mounted on a water faucet to function as a secondary control of operation of the control handle and the control rod, thereby preventing the child from unintentionally touch and drive the control handle so as to protect the child, thereby enhancing the safety of the water faucet.

2. Description of the Related Art

A conventional drinking machine in accordance with the prior art comprises a water faucet provided with a drive handle that may be pressed downward or pulled upward to let hot or cold water contained in the drinking machine flow out from the water outlet of the water faucet. However, the child may unintentionally touch and drive the drive handle to let the hot water contained in the drinking machine directly flow out from the water outlet of the water faucet, so that the hot water from the water faucet will easily touch and hurt the child, thereby causing great danger to the child.

### SUMMARY OF THE INVENTION

The present invention has arisen to mitigate and/or obviate the disadvantage of the conventional water faucet of the drinking machine.

The primary objective of the present invention is to provide a safety device of a water faucet including a safety bolt mounted on a water faucet, to function as a secondary control of operation of the control handle and the control rod, thereby preventing the child from unintentionally touch and drive the control handle so as to protect the child, thereby greatly enhancing the safety of the water faucet.

In accordance with the present invention, there is provided a safety device of a water faucet, comprising a safety bolt mounted on a water faucet, the water faucet including a housing containing therein a control rod which has one end protruded outward from the housing of the water faucet, a control handle mounted outside of the water faucet and having one end pivotally mounted on the one end of the control rod for driving the control rod to move therewith so as to control a water output of the water faucet;

wherein, the control rod is formed with a locking groove, the safety bolt is movably mounted in a side wall of the housing of the water faucet and has a first end formed with an operation portion detachably secured in the locking groove of the control rod, and a second end formed with a control knob protruded outward from the side wall of the housing of the water faucet;

the safety bolt can be pushed by the control knob to move the operation portion to lock in the locking groove of the control rod, thereby locking the control rod without movement, so that the water faucet cannot output water when the control rod is driven by the control handle;

the safety bolt can be pulled by the control knob to move the operation portion to detach from the locking groove of the control rod, thereby releasing the control rod, so that the water faucet can output water when the control rod is driven by the control handle.

The safety bolt is protruded with a catch flange, so that when the safety bolt is pulled outward from the side wall of the housing of the water faucet, the catch flange is rested on an inner periphery of the side wall of the housing of the water faucet, thereby limiting a final displacement of the safety bolt.

Preferably, the side wall of the housing of the water faucet has an inner periphery formed with a catch lug extended radially inward, so that when the safety bolt is pulled outward from the side wall of the housing of the water faucet, the catch flange is rested on the catch lug, thereby limiting a further displacement of the safety bolt.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a safety device of a water faucet in accordance with the present invention;

FIG. 2 is a side plan cross-sectional view of the safety device of a water faucet as shown in FIG. 1; and

FIG. 3 is a schematic operational view of the safety device of a water faucet as shown in FIG. 1 in use.

### DETAILED DESCRIPTION OF THE INVENTION

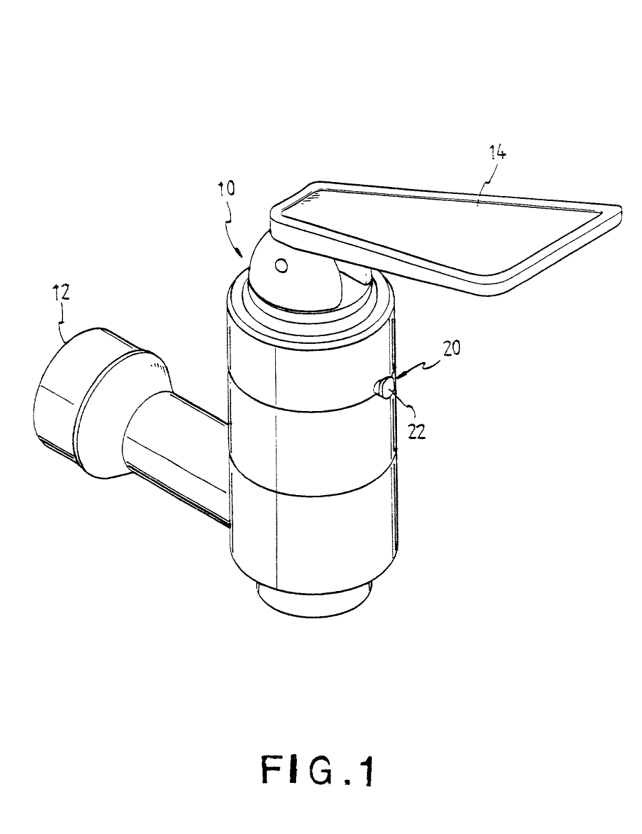

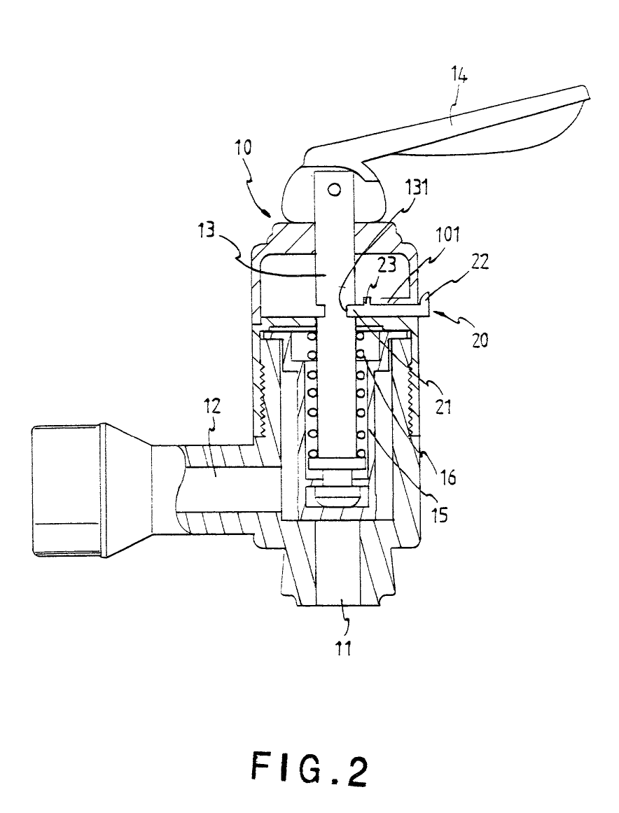

Referring to the drawings and initially to FIGS. 1 and 2, a safety device of a water faucet of a drinking machine in accordance with the present invention comprises a safety bolt 20 mounted on a water faucet 10.

The water faucet 10 includes a housing having a water outlet 11, and a water inlet 12 which communicate with each other in the housing of the water faucet 10. The housing of the water faucet 10 contains therein a control rod 13 which has one end protruded outward from the housing of the water faucet 10. A control handle 14 is mounted outside of the water faucet 10 and has one end pivotally mounted on the one end of the control rod 13 for driving the control rod 13 to move therewith so as to control the water output of the water faucet 10. An elastic retractable water control bushing 15 made of rubber and a spring 16 are mounted on the control rod 13.

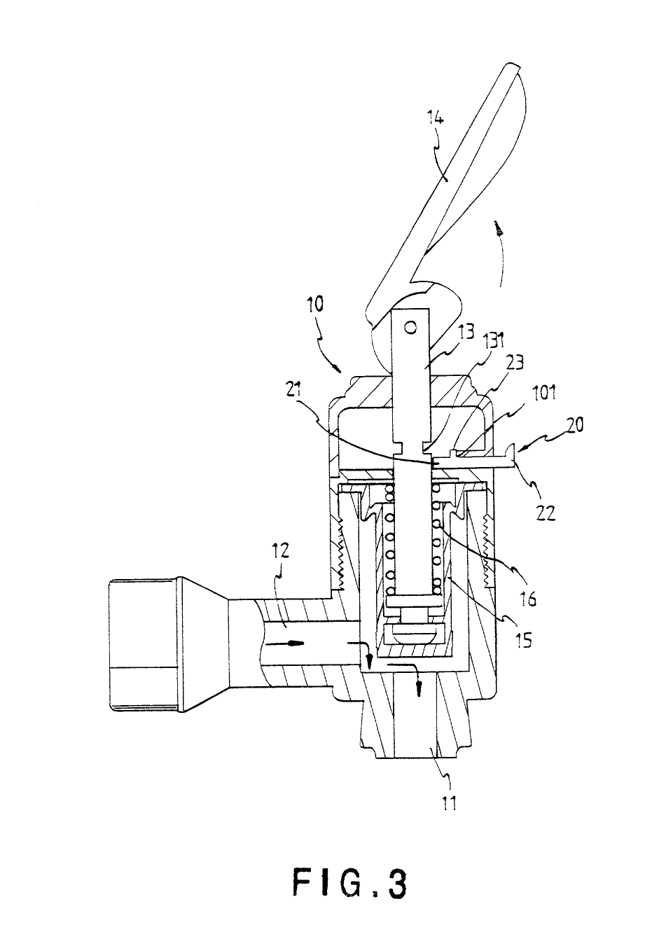

The water control bushing 15 initially closes and seals the water outlet 11 of the water faucet 10 as shown in FIG. 2, so that the water cannot flow out. The control handle 14 may then be driven by pulling the control handle 14 upward or pressing the control handle 14 downward. When the control handle 14 of the water faucet 10 is driven to pivot upward as shown in FIG. 3, the control rod 13 is moved upward to compress and retract the water control bushing 15, thereby detaching the water control bushing 15 from the water outlet 11 to open the water outlet 11 of the water faucet 10, thereby connecting the water inlet 12 to the water outlet 11, so that the water may be introduced through the water inlet 12 into the water outlet 11 to flow outward from the water outlet 11 of the water faucet 10.

The control rod 13 is formed with a locking groove 131. The safety bolt 20 is movably mounted in a side wall of the housing of the water faucet 10 and has a first end formed with an operation portion 21 detachably secured in the locking groove 131 of the control rod 13, and a second end formed with a control knob 22 protruded outward from the side wall of the housing of the water faucet 10.

The safety bolt 20 can be pushed inward by the control knob 22 to move the operation portion 21 inward to lock in the locking groove 131 of the control rod 13 as shown in FIG. 2, thereby locking the control rod 13 by the operation portion 21 of the safety bolt 20, so that the control rod 13 cannot be driven to move by the control handle 14. In such a manner, the water control bushing 15 tightly closes and seals the water outlet 11 of the water faucet 10 as shown in FIG. 2, so that the water cannot flow out from the water outlet 11 of the water faucet 10, thereby preventing the child from unintentionally touch and drive the control handle 14 to lift the control rod 13 to let the water flow out from the water outlet 11 of the water faucet 10, so as to protect the child from being hurt, thereby greatly enhancing the safety of the water faucet 10.

The safety bolt 20 can also be pulled outward by the control knob 22 to move the operation portion 21 to detach from the locking groove 131 of the control rod 13, thereby releasing the control rod 13 as shown in FIG. 3, so that the water can flow out through the water outlet 11 of the water faucet 10 when the control rod 13 is driven to lift by the control handle 14.

The safety bolt 20 is protruded with a catch flange 23, so that when the safety bolt 20 is pulled outward from the side wall of the housing of the water faucet 10, the catch flange 23 is rested on the inner periphery of the side wall of the housing of the water faucet 10, thereby limiting a final displacement of the safety bolt 20.

Preferably, the inner periphery of the side wall of the housing of the water faucet 10 is formed with a catch lug 101 extended radially inward, so that when the safety bolt 20 is pulled outward from the side wall of the housing of the water faucet 10, the catch flange 23 is rested on the catch lug 101, thereby limiting a further displacement of the safety bolt 20.

Accordingly, the safety device of the present invention includes a safety bolt mounted on a water faucet to function as a secondary control of operation of the control handle and the control rod, thereby preventing the child from unintentionally touch and drive the control handle so as to protect the child, thereby greatly enhancing the safety of the water faucet.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A safety device of a water faucet, comprising a safety bolt (20) mounted on a water faucet (10), said water faucet (10) including a housing containing therein a control rod (13) which has one end protruded outward from said housing of said water faucet (10), a control handle (14) mounted outside of said water faucet (10) and having one end pivotally mounted on said one end of said control rod (13) for driving said control rod (13) to move therewith so as to control a water output of said water faucet (10);
wherein, said control rod (13) is formed with a locking groove (131), said safety bolt (20) is movably mounted in a side wall of said housing of said water faucet (10) and has a first end formed with an operation portion (21) detachably secured in said locking groove (131) of said control rod (13), and a second end formed with a control knob (22) protruded outward from said side wall of said housing of said water faucet (10);
said safety bolt (20) can be pushed by said control knob (22) to move said operation portion (21) to lock in said locking groove (131) of said control rod (13), thereby locking said control rod (13) without movement, so that said water faucet (10) cannot output water when said control rod (13) is driven by said control handle (14);
said safety bolt (20) can be pulled by said control knob (22) to move said operation portion (21) to detach from said locking groove (131) of said control rod (13), thereby releasing said control rod (13), so that said water faucet (10) can output water when said control rod (13) is driven by said control handle (14).

2. The safety device of a water faucet in accordance with claim 1, wherein said safety bolt (20) is protruded with a catch flange (23), so that when said safety bolt (20) is pulled outward from said side wall of said housing of said water faucet (10), said catch flange (23) is rested on an inner periphery of said side wall of said housing of said water faucet (10), thereby limiting a final displacement of said safety bolt (20).

3. The safety device of a water faucet in accordance with claim 1, wherein said side wall of said housing of said water faucet (10) has an inner periphery formed with a catch lug (101) extended radially inward, so that when said safety bolt (20) is pulled outward from said side wall of said housing of said water faucet (10), said catch flange (23) is rested on said catch lug (101), thereby limiting a further displacement of said safety bolt (20).
